(19) United States
(12) Patent Application Publication
(10) Pub. No.: US 2020/0257312 A1
(43) Pub. Date: Aug. 13, 2020

(54) INFORMATION PROCESSING SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Koichi SUZUKI, Miyoshi-shi (JP); Toru NISHITANI, Nisshin-shi (JP); Jun USAMI, Toyota-shi (JP); Minami YODA, Tokyo (JP); Kensuke KOIKE, Nisshin-shi (JP); Tsuyoshi OGAWA, Okazaki-shi (JP); Yohei TANIGAWA, Toyota-shi (JP)

(73) Assignee: TOYOTA JIDOSHA KABUSHIKI KAISHA, Toyota-shi (JP)

(21) Appl. No.: 16/783,711

(22) Filed: Feb. 6, 2020

(30) Foreign Application Priority Data
Feb. 13, 2019 (JP) 2019-023629

(51) Int. Cl. G05D 1/02; G08G 1/00; G05D 1/00

(52) U.S. Cl. CPC G05D 1/0293; G08G 1/22; G05D 2201/0213; G05D 1/0295; G05D 1/0088

(57) ABSTRACT

An information processing system that manages traveling of a plurality of autonomous vehicles when the autonomous vehicles travel in a platoon is provided. Each of the autonomous vehicles is equipped with a motor, and an operation source as a substance consumed for operating the motor. The information processing system includes a controller configured to obtain a parameter correlated with an operation source remaining amount as a remaining amount of the operation source installed on each of the autonomous vehicles, and determine a traveling order of the autonomous vehicles traveling in the platoon, based on the parameter of each of the autonomous vehicles.

### INCORPORATION BY REFERENCE

The disclosure of Japanese Patent Application No. 2019-023629 filed on Feb. 13, 2019 including the specification, drawings and abstract is incorporated herein by reference in its entirety.

### BACKGROUND

### 1. Technical Field

The disclosure relates to an information processing system, information processing method, and a non-transitory storage medium.

### 2. Description of Related Art

In recent years, development of vehicles capable of traveling autonomously (which may be referred to as “autonomous vehicles”) has been proceeding. As a technology for controlling operation of the autonomous vehicles, a so-called platooning technology has been proposed (see, for example, Japanese Unexamined Patent Application Publication No. 2018-191408 (JP 2018-191408 A)). According to the platooning technology, when two or more autonomous vehicles travel on the same lane, the autonomous vehicles are controlled to travel at equal speed, while keeping a given distance (inter-vehicle distance) between the autonomous vehicles.

### SUMMARY

This disclosure provides a technology for extending travelable distances of a plurality of autonomous vehicles to the longest possible distances, when the autonomous vehicles travel in a platoon.

According to the disclosure, when a plurality of autonomous vehicles, each of which is equipped with a motor and an operation source as a substance consumed for operating the motor, travels in a platoon, the traveling order of the autonomous vehicles is determined, based on the remaining amount of the operation source (operation source remaining amount) installed on each autonomous vehicle.

A first aspect of the disclosure is concerned with an information processing system that manages traveling of a plurality of autonomous vehicles when the autonomous vehicles travel in a platoon. Each of the autonomous vehicles is equipped with a motor, and an operation source as a substance consumed for operating the motor. The information processing system includes a controller configured to obtain a parameter correlated with an operation source remaining amount as a remaining amount of the operation source installed on each of the autonomous vehicles, and determine a traveling order of the autonomous vehicles traveling in the platoon, based on the parameter of each of the autonomous vehicles.

A second aspect of the disclosure is concerned with an information processing method for managing traveling of a plurality of autonomous vehicles when the autonomous vehicles travel in a platoon. Each of the autonomous vehicles is equipped with a motor, and an operation source as a substance consumed for operating the motor. The information processing method includes the steps of: obtaining a parameter correlated with an operation source remaining amount as a remaining amount of the operation source installed on each of the autonomous vehicles, by a computer, and determining a traveling order of the autonomous vehicles traveling in the platoon, based on the parameter of each of the autonomous vehicles, by the computer.

A third aspect of the disclosure is concerned with a non-transitory storage medium storing an information processing program for managing traveling of a plurality of autonomous vehicles when the autonomous vehicles travel in a platoon. Each of the autonomous vehicles is equipped with a motor, and an operation source as a substance consumed for operating the motor. The information processing program causes a computer to execute the steps of: obtaining a parameter correlated with an operation source remaining amount as a remaining amount of the operation source installed on each of the autonomous vehicles, and determining a traveling order of the autonomous vehicles traveling in the platoon, based on the parameter of each of the autonomous vehicles.

According to the disclosure, when a plurality of autonomous vehicles travels in a platoon, the travelable distances of the autonomous vehicles can be extended to the longest possible distances.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a view generally showing a travel management system to which the embodiment is applied;

FIG. 2 is a block diagram schematically showing one example of constituent components included in the travel management system;

FIG. 3 is a view showing one example of autonomous vehicles traveling in a platoon;

FIG. 4 is a view showing an example of a vehicle information table in the first embodiment;

FIG. 5 is a flowchart illustrating the flow of processing performed by a server device when two or more autonomous vehicles traveling on the same route are detected;

FIG. 6 is a flowchart illustrating the flow of processing performed by the server device when two or more autonomous vehicles travel in a platoon, in a first modified example of the first embodiment;

FIG. 7 is a view showing an example of a platooning information table in the first modified example of the first embodiment;

FIG. 8 is a view showing an example of a vehicle information table in a second embodiment; and

FIG. 9 is a flowchart illustrating the flow of processing performed by a server device when two or more autonomous vehicles traveling on the same route are detected, in the second embodiment.

### DETAILED DESCRIPTION OF EMBODIMENTS

The embodiments are concerned with an information processing system that manages traveling of a plurality of autonomous vehicles. Each of the autonomous vehicles is equipped with a motor, and an operation source as a substance consumed for operating the motor. When two or more autonomous vehicles travel on the same lane, the autonomous vehicles are controlled to travel in a platoon at equal speed, while keeping a predetermined inter-vehicle distance, so that the amount of the operation source consumed in each autonomous vehicle can be kept small or reduced.

When the two or more autonomous vehicles travel in a platoon, the consumption rate of the operation source in each autonomous vehicle varies according to the traveling position of the vehicle in the platoon. For example, the consumption rate of the operation source in the autonomous vehicle that travels first (or takes the lead) in the platoon is higher than those of the operation sources in the autonomous vehicles that travel in the second and subsequent positions. Also, among the autonomous vehicles that travel in the second and subsequent positions in the platoon, the consumption rate of the operation source varies between the autonomous vehicle that travels at the tail end, and the autonomous vehicle that travels in the middle of the platoon (between the lead autonomous vehicle and the tail-end autonomous vehicle).

Thus, when two or more autonomous vehicles are caused to travel in a platoon, a controller of the information processing system according to the embodiment obtains a parameter correlated with the remaining amount (operation source remaining amount) of the operation source installed on each autonomous vehicle. Then, the controller determines the traveling order during platooning, based on the parameter obtained with respect to each autonomous vehicle. Thus, when the two or more autonomous vehicles travel in a platoon, the traveling position of each autonomous vehicle in the platoon can be set to the one suited for the operation source remaining amount of the autonomous vehicle. As a result, the travelable distances of the autonomous vehicles for use in platooning can be extended to the longest possible distances.

In this connection, the controller may obtain the operation source remaining amount of each of the autonomous vehicles for use in platooning, as the parameter. In this case, the controller may determine the traveling order, such that the autonomous vehicle having the largest operation source remaining amount, among the two or more autonomous vehicle, takes the lead in the platoon. As a result, the autonomous vehicles having the smaller operation source remaining amounts than the lead autonomous vehicle are placed at the second and subsequent positions; therefore, the consumption rates of the operation sources in the second and subsequent autonomous vehicles can be made lower than that of the lead autonomous vehicle. Consequently, the travelable distances of the autonomous vehicles for use in platooning can be extended.

Also, the controller estimates the travelable distance of each of the autonomous vehicles for use in platooning, based on the operation source remaining amount of the autonomous vehicle, obtains the scheduled traveling distance of each autonomous vehicle, and calculate a margin (difference, ratio) of the travelable distance relative to the scheduled traveling distance, for each of the autonomous vehicles, so as to obtain the margin for each of the autonomous vehicles, as the parameter. Then, the controller may determine the traveling order, such that one of the autonomous vehicles having the largest margin takes the lead in the platoon. As a result, the autonomous vehicles having the smaller margins than the lead autonomous vehicle are placed at the second and subsequent positions, so that the consumption rates of the operating sources in the second and subsequent autonomous vehicles can be made lower than that of the lead autonomous vehicle. Consequently, the autonomous vehicles traveling in the second and subsequent positions are able to accomplish the scheduled traveling distances with greater certainty.

While the two or more autonomous vehicles are traveling in a platoon, the relationship in magnitude of the operation source remaining amount or the margin among the autonomous vehicles may be changed. For example, the operation source remaining amount or margin of the lead autonomous vehicle traveling first may become smaller than the operation source remaining amount or margin of the autonomous vehicle traveling in the second or subsequent position. Thus, the controller may further execute the steps of: determining whether the traveling order needs to be changed, based on the parameter of each autonomous vehicle obtained while the autonomous vehicles are traveling in a platoon, and determining the traveling order again, based on the parameter of each of the autonomous vehicles, when it determines that the traveling order needs to be changed. In this manner, the consumption rates of the operation sources in the autonomous vehicles for use in platooning can be more favorably reduced. Consequently, the travelable distances of the autonomous vehicles for use in platooning can be extended with greater certainty, or the autonomous vehicles are more likely to accomplish the scheduled traveling distances with greater certainty.

In the case where two or more groups of autonomous vehicles that travel in platoons are set, if a group including an autonomous vehicle having the smallest operation source remaining amount or margin is formed of autonomous vehicles having relatively small operation source remaining amounts or margins, it may be difficult to favorably extend the travelable distance of the autonomous vehicle having the smallest operation source remaining amount or margin, or it may be difficult for the autonomous vehicle in question to accomplish the scheduled traveling distance. Thus, in the information processing system, where two or more groups of autonomous vehicles that travel in platoons are set, the controller may set the groups, such that the autonomous vehicle having the largest parameter and the autonomous vehicle having the smallest parameter are included in the same group. If the groups are set in this manner, the autonomous vehicle having the smallest operation source remaining amount or margin can travel in the second or subsequent position of the group in which the autonomous vehicle having the largest operation source remaining amount or margin travels first. Thus, the travelable distance of the autonomous vehicle having the smallest operation source remaining amount or margin can be extended to the largest possible distance, or the autonomous vehicle in question is more likely to accomplish the scheduled traveling distance with greater certainty.

In the following, some embodiments will be described based on the drawings. The dimensions, materials, shapes, relative locations, etc. of constituent components described in the embodiments are not supposed to limit the technical scope of the disclosure to these details unless otherwise stated.

### First Embodiment

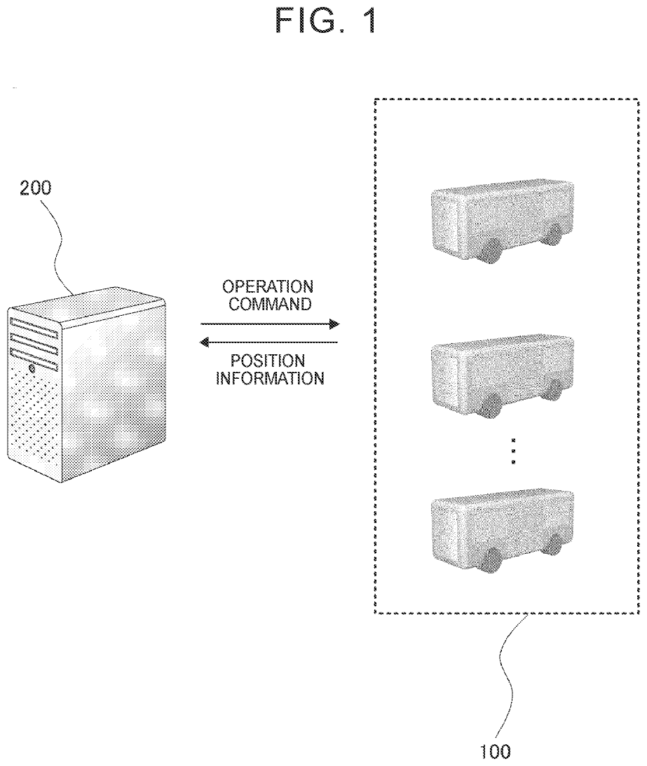

In a first embodiment that will be described below, this disclosure is applied to a travel management system that includes a plurality of autonomous vehicles, and manages traveling of these autonomous vehicles. In this embodiment, an electric automobile equipped with an electric motor as the motor, and a battery for storing electric power as the operation source, is used as the autonomous vehicle. FIG. 1 shows the general configuration of the travel management system to which the disclosure is applied. The travel management system shown in FIG. 1 includes a plurality of autonomous vehicles 100 that travels autonomously according to given operation commands, and a server device 200 that generates the operation commands to the respective autonomous vehicles 100. The autonomous vehicle 100 is an automatic driving or self-driving vehicle that provides predetermined service. The server device 200 manages and controls operation of each autonomous vehicle 100.

Each autonomous vehicle 100 is a multipurpose mobile object of which specifications, such as the interior and exterior, can be easily changed depending on the intended use, and is also a vehicle that can travel autonomously on a road. The autonomous vehicle 100 is, for example, a transit bus that transports a plurality of users on a given route, on-demand taxi that is operated along a route that meets a request from a user, freight transport vehicle that transports freight or cargo along a given route, or a stay-type passenger transport vehicle (e.g., vehicle in which a hotel facility, workspace, or the like, is installed in the interior) that is operated along a route that meets a request from a user. The autonomous vehicle 100 of this embodiment is not necessarily a vehicle which no one other than passengers boards. For example, a service staff member who serves passengers, security staff member who ensures the safety of the autonomous vehicle 100, pickup and delivery staff member who loads and unloads goods, or the like, may also be on board the vehicle. Also, the autonomous vehicle 100 may not necessarily be a vehicle capable of full autonomous traveling, but may be a vehicle that is driven by a driving staff member or driven with aid, depending on a situation.

The server device 200 generates an operation command to each autonomous vehicle 100. When the autonomous vehicle 100 is an on-demand taxi, for example, the server device 200 obtains a point to which the vehicle is to be dispatched, and a destination, in response to a request from a user, and sends an operation command to the effect that “transport a person from the point of departure to the destination”, to the autonomous vehicle 100 having taxi equipment, which is selected from the autonomous vehicles 100 traveling in the neighborhood. Thus, the autonomous vehicle 100 that received the operation command from the server device 200 is able to travel along a route based on the operation command. The operation command does not necessarily include a command for travel between the point of departure and the destination. For example, the command may be “travel to a given point and collect a package”, or “stop for a given period of time at a sightseeing spot that exists on a given route”. Thus, the operation command may include operation, other than traveling, which should be performed by the autonomous vehicle 100.

Also, the server device 200 has a function of sending commands for efficiently running a plurality of autonomous vehicles 100, to the autonomous vehicles 100, when the autonomous vehicles 100 travel on the same lane. More specifically, the server device 200 causes the autonomous vehicles 100 to travel in a platoon at equal speed, while keeping a predetermined inter-vehicle distance. At this time, the server device 200 determines the traveling order, based on the state of charge (SOC) of the battery in each of the autonomous vehicles 100 for use in platooning. Then, the server device 200 sends commands to cause the autonomous vehicles 100 to travel in a platoon, according to the determined traveling order, to the autonomous vehicles 100.

### System Configuration

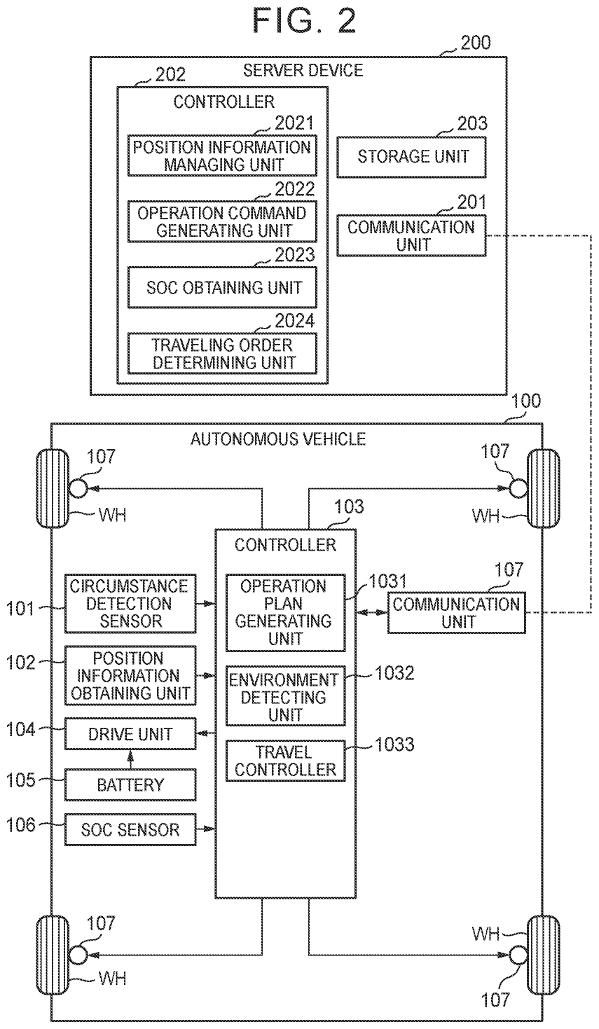

Next, constituent components of the travel management system according to this embodiment will be described in detail. FIG. 2 is a block diagram schematically showing one example of the configurations of the autonomous vehicle 100 and the server device 200 shown in FIG. 1. In the example shown in FIG. 2, only one autonomous vehicle 100 is illustrated, but it is to be understood that a plurality of autonomous vehicles 100 is included in the travel management system.

As described above, the autonomous vehicle 100 travels according to an operation command obtained from the server device 200, and is in the form of an electric automobile driven by an electric motor as the motor. The autonomous vehicle 100 includes a circumstance detection sensor 101, position information obtaining unit 102, controller 103, drive unit 104, battery 105, SOC sensor 106, communication unit 107, and so forth.

The circumstance detection sensor 101 is a means for sensing circumstances of the vehicle, and typically includes a stereo camera, laser scanner, LIDAR (Light Detection and Ranging), radar, or the like. Information obtained by the circumstance detection sensor 101 is transmitted to the controller 103.

The position information obtaining unit 102 is a means for obtaining the current position of the autonomous vehicle 100, and typically includes a GPS receiver, or the like. The position information obtaining unit 102 obtains the current position of the autonomous vehicle 100 at predetermined intervals, and transmits information about the obtained current position, to the controller 103. Each time the controller 103 receives the position information from the position information obtaining unit 102, it sends the position information to the server device 200. Namely, the position information of the autonomous vehicle 100 is transmitted from the autonomous vehicle 100 to the server device 200 at predetermined intervals. Thus, the server device 200 is able to grasp the current position of each autonomous vehicle 100.

The controller 103 is a computer that controls operation of the autonomous vehicle 100 based on the information obtained from the circumstance detection sensor 101, and controls traveling conditions of the autonomous vehicle 100 according to a command from the server device 200. The controller 103 is in the form of a microcomputer, for example. The controller 103 of this embodiment has an operation plan generating unit 1031, environment detecting unit 1032, and travel controller 1033, as function modules. Each function module may be implemented by causing a central processing unit (CPU) (not shown) to execute a program stored in a storage means, such as a read-only memory (ROM) (not shown).

The operation plan generating unit 1031 obtains an operation command from the server device 200, and generates an operation plan for the self-vehicle. In this embodiment, the operation plan includes data that specifies a route along which the autonomous vehicle 100 travels, and operation to be performed by the autonomous vehicle 100 on a part or the whole of the route. Examples of the data included in the operation plan include those as follows, for example.

(1) Data in the form of a set of road links representing a route (scheduled traveling route) along which the self-vehicle is scheduled to travel

For example, the operation plan generating unit 1031 may generate the “scheduled traveling route” mentioned herein, based on the point of departure and destination provided by the operation command from the server device 200, while referring to map data stored in a storage device installed on the autonomous vehicle 100. The “scheduled traveling route” may also be generated using external service, or may be provided by the server device 200. When the “scheduled traveling route” is generated by the operation plan generating unit 1031 of the autonomous vehicle 100 or by using the external service, the “scheduled traveling route” thus generated is transmitted to the server device 200 via the communication unit 107 that will be described later.

(2) Data representing operation to be performed by the self-vehicle at a given point on the scheduled traveling route

The operation to be performed by the self-vehicle includes, for example, “travel in a platoon with other autonomous vehicles”, “let a passenger get on or off the vehicle”, “load or unload cargo”, “stop for a given period for the sake of sightseeing by a passenger”, and so forth, but is not limited to these.

The environment detecting unit 1032 detects the environment around the vehicle, based on data obtained by the circumstance detection sensor 101. For example, objects of detection include the number and positons of the lanes, the number and positions of vehicles present around the self-vehicle, the number and positions of obstacles (e.g., pedestrian, bicycle, structural object, construction, etc.) present around the self-vehicle, structure of the road, road signs, and so forth. However, the objects of detection are not limited to these, but may be any objects provided that they are necessary for autonomous traveling. Also, the environment detecting unit 1032 may track any object thus detected. For example, the environment detecting unit 1032 may calculate the relative velocity of a certain object, from a difference between the coordinates of the object detected in a previous step, and the current coordinates of the object.

The travel controller 1033 controls traveling of the self-vehicle, based on the operation plan generated by the operation plan generating unit 1031, environment data generated by the environment detecting unit 1032, and the position information of the self-vehicle obtained by the position information obtaining unit 102. For example, the travel controller 1033 causes the self-vehicle to travel along the scheduled traveling route generated by the operation plan generating unit 1031, such that no obstacle enters a predetermined safety area around the self-vehicle. A known method may be employed for causing the self-vehicle to travel autonomously. The travel controller 1033 also has a function of controlling traveling of the self-vehicle according to a command from the server device 200. For example, the travel controller 1033 causes the self-vehicle to travel in a platoon with other autonomous vehicles 100, according to a command from the server device 200.

The drive unit 104 is a means for driving the self-vehicle, based on a command generated by the travel controller 1033. The drive unit 104 includes, for example, an electric motor, braking device, steering device, and so forth.

The battery 105 stores electric power (operation source) for operating the electric motor of the drive unit 104. The battery 105 is adapted to be externally charged with electric power from an external power supply installed at a certain charging point or station.

The SOC sensor 106 detects the SOC of the battery 105. The SOC mentioned herein is the ratio (charging rate) of the amount of electric power that can be discharged at the current point in time, to the maximum amount of electric power that can be stored in the battery 105 (the capacity of electric power stored when the battery 105 is fully charged).

The communication unit 107 is a communicating means for connecting the autonomous vehicle 100 to a network. In this embodiment, the communication unit 107 can communicate with other devices (such as the server device 200) via the network, using mobile communications service, such as 3G (3rd Generation) or LTE (Long Term Evolution). The communication unit 107 may further have a communicating means for conducting inter-vehicle communications with other autonomous vehicles 100. In this embodiment, the communication unit 107 sends information on the current position of the self-vehicle obtained by the position information obtaining unit 102, operation plan (scheduled traveling route) generated by the operation plan generating unit 1031, and so forth, to the server device 200.

Next, the server device 200 will be described. The server device 200 manages the traveling positions of a plurality of autonomous vehicles 100, and sends operation commands to the vehicles 100. The server device 200 has a communication unit 201, controller 202, and storage unit 203. The communication unit 201 is a communication interface similar to the communication unit 107 of the autonomous vehicle 100, for communicating with the autonomous vehicles 100 via the network.

The controller 202 is a means for controlling the server device 200. The controller 202 is provided by a central processing unit (CPU), for example. The controller 202 of this embodiment has a position information managing unit 2021, operation command generating unit 2022, SOC obtaining unit 2023, and traveling order determining unit 2024, as function modules. These function modules may be implemented by causing the CPU (not shown) to execute programs stored in a storage means, such as ROM (not shown).

The position information managing unit 2021 manages the current position of each of the autonomous vehicles 100 under the control of the server device 200. More specifically, the position information managing unit 2021 receives current position information at given intervals, from a plurality of autonomous vehicles 100 under the control of the server device 200, and stores the information in the storage unit 203 that will be described later, such that the information is associated with the date and time.

When the operation command generating unit 2022 receives a dispatch request for dispatching an autonomous vehicle 100, from the outside, it determines the autonomous vehicle 100 to be dispatched, and generates an operation command that meets the dispatch request. Examples of the dispatch request are indicated below, but the dispatch request may be other than these examples.
(1) Request for transporting passengers and/or cargo, which is made by designating a point of departure and a destination, or a traveling route.
(2) Dispatch request for dispatching an autonomous vehicle having a particular function. This request is to ask for dispatch of an autonomous vehicle 100 having a function of an accommodation facility (hotel) for a passenger, or a workspace (e.g., a private office, sales office, etc.) for a passenger, for example. The autonomous vehicle 100 may be dispatched to a single spot, or two or more spots. When the autonomous vehicle 100 is dispatched to two or more spots, it may provide service at each of the spots.

The dispatch request as described above is obtained from the user via the Internet, for example. In this connection, the dispatch request is not necessarily transmitted from a general user, but may be transmitted from a business operator who operates the autonomous vehicle 100, for example. The autonomous vehicle 100 to which the operation command is transmitted is determined, according to the current position information of each autonomous vehicle 100 obtained by the position information managing unit 2021, the specifications (the use or application of the interior/exterior equipment installed on the vehicle) of each autonomous vehicle 100 grasped in advance by the server device 200, and so forth. Then, once the autonomous vehicle 100 to which the operation command is to be transmitted is determined, the operation command generated by the operation command generating unit 2022 is transmitted to the autonomous vehicle 100 via the communication unit 201.

The operation command generating unit 2022 of this embodiment also has a function of generating a command to cause two or more autonomous vehicles 100 to travel in a platoon, when the two or more autonomous vehicles 100 traveling on the same route are detected, from the position information of each autonomous vehicle 100 received by the position information managing unit 2021. This command is generated based on the traveling position of each autonomous vehicle 100, which is determined by the traveling order determining unit 2024 that will be described later. Namely, this command is generated so as to cause the autonomous vehicles 100 traveling on the same route, to travel in a platoon according to the traveling order determined by the traveling order determining unit 2024.

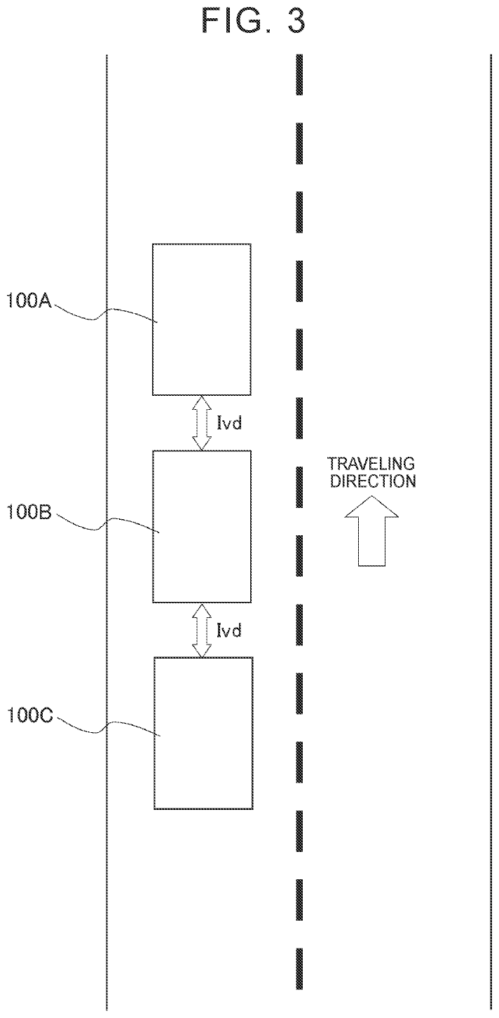

In the case where three autonomous vehicles 100A, 100B, 100C travel on the same route, such that the autonomous vehicle 100A travels first, namely, is in the first traveling position, the autonomous vehicle 100B is in the second traveling position, and the autonomous vehicle 100C is in the third traveling position, the operation command generating unit 2022 generates commands to make the autonomous vehicle 100A travel first, make the autonomous vehicle 100B follow the autonomous vehicle 100A with a given inter-vehicle distance Ivd therebetween, and make the autonomous vehicle 100C follow the autonomous vehicle 100B with the given inter-vehicle distance Ivd therebetween, as shown in FIG. 3. More specifically, the operation command generating unit 2022 generates a command to make the autonomous vehicle 100A travel first, among the three autonomous vehicles 100A to 100C. Also, the operation command generating unit 2022 generates a command to make the autonomous vehicle 100B travel behind (follow) the autonomous vehicle 100A, while keeping the inter-vehicle distance to the autonomous vehicle 100A constant (predetermined inter-vehicle distance Ivd). Further, the operation command generating unit 2022 generates a command to make the autonomous vehicle 100C follow the autonomous vehicle 100B.

The SOC obtaining unit 2023 manages the SOC of the battery 105 in each of the autonomous vehicles 100 under the control of the server device 200. In this embodiment, when two or more autonomous vehicles 100 traveling on the same route are detected, the SOC obtaining unit 2023 obtains information (SOC information) indicating the SOC of the battery 105 in each of these autonomous vehicles 100, from each autonomous vehicle 100, via the communication unit 201. The SOC obtaining unit 2023 may receive the latest SOC information at given intervals, from the autonomous vehicles 100 under the control of the server device 200. The SOC information obtained by the SOC obtaining unit 2023 is stored in the storage unit 203 that will be described later.

When the two or more autonomous vehicles 100 traveling on the same route are caused to travel in a platoon, the traveling order determining unit 2024 determines the traveling order of the autonomous vehicles 100. In this embodiment, the traveling order determining unit 2024 sets the traveling position of each autonomous vehicle 100, based on the SOC of the battery 105 in each autonomous vehicle 100. More specifically, the traveling order determining unit 2024 obtains the SOC of the battery 105 in each of the autonomous vehicles 100 traveling on the same route, by referring to a vehicle information table stored in the storage unit 203 that will be described later. Then, the traveling order determining unit 2024 sets the traveling position of the autonomous vehicle 100 having the largest SOC of the battery 105, among the two or more autonomous vehicles 100, to the first (lead) position. In the case where there are three or more autonomous vehicles 100 for use in platooning, the traveling position of the autonomous vehicle 100 having the smallest SOC of the battery 105 is set to a position at which the travel resistance is smallest (for example, a position between the lead vehicle and the tail-end vehicle), among the second and subsequent positions,. It is thus possible to reduce the travel resistance of the autonomous vehicle 100 having the smallest SOC of the battery 105 as much as possible, and reduce the travel resistance of the autonomous vehicles 100 for use in platooning. Namely, it is possible to reduce the consumption rates of the battery power in the autonomous vehicles 100 for use in platooning, while minimizing the consumption rate of the battery power in the autonomous vehicle 100 having the smallest SOC of the battery 105

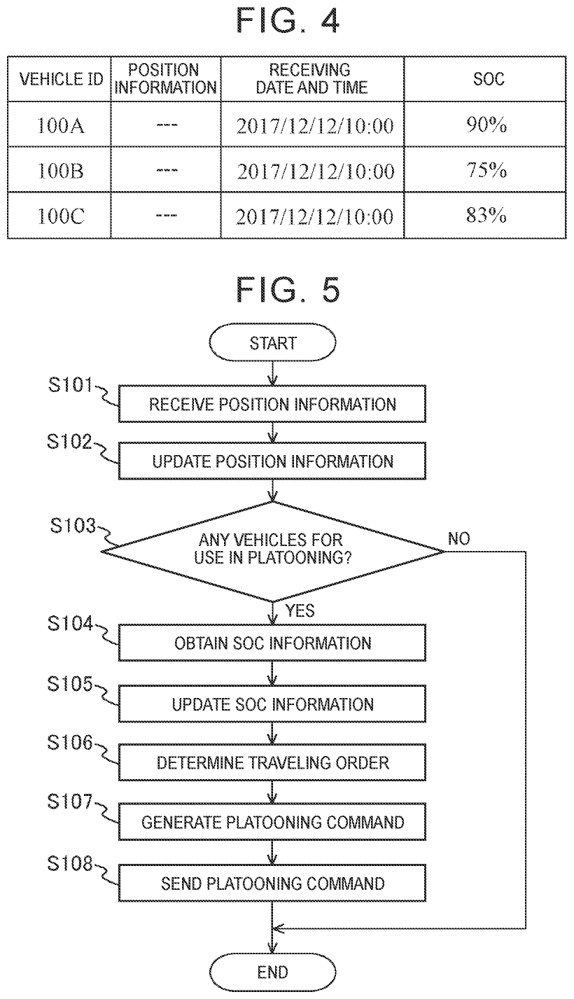

The storage unit 203 is a means for storing information, and is provided by a storage medium, such as a magnetic disc, or a flash memory. The storage unit 203 of this embodiment stores vehicle information concerning the individual autonomous vehicles 100, such that the vehicle information is associated with identification information of the corresponding one of the autonomous vehicles 100. Here, one example of the vehicle information stored in the storage unit 203 will be described with reference to FIG. 4. FIG. 4 shows a table of the vehicle information. The vehicle information table shown in FIG. 4 has respective fields of vehicle ID, position information, receiving date and time, and SOC, for example. In the vehicle ID field, vehicle identification information (vehicle ID) for identifying each of the autonomous vehicles 100 is entered. In the position information field, the current position information which the position information managing unit 2021 receives from each of the autonomous vehicles 100 is entered. The current position information entered in the position information field may be, for example, information indicating the address of the place at which the autonomous vehicle 100 is located, or information indicating coordinates (longitude and latitude) on a map, of the place at which the autonomous vehicle 100 is located. In the receiving date and time field, the date and time at which the current position information entered in the position information field was received by the position information managing unit 2021 are entered. The information entered in the position information field and the receiving date and time field is updated each time the position information managing unit 2021 receives position information from each autonomous vehicle 100 (at predetermined intervals as described above). In the SOC field, SOC information which the SOC obtaining unit 2023 receives from each of the autonomous vehicles 100 is entered. The information entered in the SOC field is updated each time the SOC obtaining unit 2023 receives the SOC information from each autonomous vehicle 100.

### Flow of Processing

Here, the flow of processing of the server device 200 according to this embodiment will be described. FIG. 5 is a flowchart illustrating the flow of processing performed by the server device 200, when two or more autonomous vehicles 100 traveling on the same route are detected.

In FIG. 5, when the communication unit 201 of the server device 200 receives the current position information transmitted at given intervals from each of the autonomous vehicles 100 under the control of the server device 200 (step S101), the position information managing unit 2021 updates information in the position information field and the receiving date and time field in the vehicle information table of the storage unit 203 (step S102). Here, the current position information transmitted from each autonomous vehicle 100 includes the identification information (vehicle ID) of each autonomous vehicle 100, in addition to the information indicating the current position of each autonomous vehicle 100. Thus, the position information managing unit 2021 can update the information in the position information field and the receiving date and time field of the vehicle information table, by accessing the vehicle information table corresponding to the vehicle ID.

Once the information in the position information field and the receiving date and time field in the vehicle information table is updated as described above, the operation command generating unit 2022 determines whether there are two or more autonomous vehicles 100 traveling on the same route, by referring to the position information field of the vehicle information table corresponding to each of the autonomous vehicles 100 under the control of the server device 200. Namely, the operation command generating unit 2022 determines whether there are vehicles for use in platooning (step S103). For example, when there is a certain autonomous vehicle 100 of which the current position is on the same route as another autonomous vehicle 100, within a given range from the current position of the latter autonomous vehicle 100, and which is traveling in the same direction as the latter autonomous vehicle 100, the operation command generating unit 2022 determines that there are vehicles for use in platooning. When the operation command generating unit 2022 determines that there are no vehicles for use in platooning (a negative decision (NO) is obtained in step S103), the processing performed by the server device 200 ends. On the other hand, when the operation command generating unit 2022 determines that there are vehicles for use in platooning (an affirmative decision (YES) is obtained in step S103), the server device 200 executes step S104 and subsequent steps.

In step S104, the SOC obtaining unit 2023 communicates with each of the autonomous vehicles 100 for use in platooning, via the communication unit 201, so as to obtain the SOC information in each of the autonomous vehicles 100. Then, the SOC obtaining unit 2023 accesses the vehicle information table corresponding to each of the autonomous vehicles 100 for use in platooning, and updates the information in the SOC field of the table (step S105).

Once the SOC information of the autonomous vehicles 100 for use in platooning is updated, as described above, the traveling order determining unit 2024 accesses the vehicle information table corresponding to each of the autonomous vehicles 100 for use in platooning, and determines the traveling order of the autonomous vehicles 100, by referring to the information in the SOC field of the table (step S106). In this embodiment, the traveling position of the autonomous vehicle 100 having the largest SOC, among the autonomous vehicles 100 for use in platooning, is set to the first (lead) position. This is because, when two or more autonomous vehicles 100 travel in a platoon, the travel resistance of the first or lead vehicle is larger than those of the following vehicles. Also, when there are three or more autonomous vehicles 100 for use in platooning, the traveling position of the autonomous vehicle 100 having the second largest SOC, among the three or more autonomous vehicles 100, is set to the tail-end position. This is because, when three or more autonomous vehicles 100 travel in a platoon, the tail-end vehicle is likely to have the second largest travel resistance, next to the lead vehicle. When there are three or more autonomous vehicles 100 for use in platooning, the traveling position of the autonomous vehicle 100 having the smallest SOC may be set to a position between the lead vehicle and the tail-end vehicle, at which the travel resistance is smallest. Here, when the three autonomous vehicles 100A to 100C indicated in FIG. 4 are used to form a platoon when traveling, the traveling position of the autonomous vehicle 100A (SOC=90%) having the largest SOC is set to the first (lead) position. Also, the traveling position of the autonomous vehicle 100C (SOC=83%) having the second largest SOC is set to the third (tail-end) position. Then, the traveling position of the autonomous vehicle 100B (SOC=75%) having the smallest SOC is set to the second position (between the lead vehicle and the tail-end vehicle).

Once the traveling order of the autonomous vehicles 100 for use in platooning is determined, the operation command generating unit 2022 generates commands (platooning commands) to make the autonomous vehicles 100 travel in a platoon (step S107). At this time, the operation command generating unit 2022 generates a command to cause the autonomous vehicle 100 of the first traveling position, among the autonomous vehicles 100 for use in platooning, to travel at the head of the autonomous vehicles 100. Then, the operation command generating unit 2022 generates a command to cause each of the autonomous vehicles 100 of the second and subsequent positions, among the autonomous vehicles 100 for use in platooning, to travel after (follow) a preceding vehicle, while keeping the inter-vehicle distance (predetermined inter-vehicle distance Ivd) to the preceding vehicle constant. When the three autonomous vehicles 100A to 100C shown in FIG. 4 above are caused to travel in a platoon, in the order of the autonomous vehicle 100A, autonomous vehicle 100B, and autonomous vehicle 100C, a command to make the autonomous vehicle 100A travel first, a command to make the autonomous vehicle 100B follow the autonomous vehicle 100A, and a command to make the autonomous vehicle 100C follow the autonomous vehicle 100B, may be generated.

Once the commands for platooning are generated as described above, the operation command generating unit 2022 sends the platooning commands, from the communication unit 201 to the autonomous vehicles 100 for use in platooning (step S108). In each of the autonomous vehicles 100 which received the platooning command, the travel controller 1033 causes the self-vehicle to travel in a platoon with other autonomous vehicles 100, according to the platooning command. Here, in the case where the three autonomous vehicles 100A to 100C shown in FIG. 4 above are caused to travel in a platoon, in the order of the autonomous vehicle 100A, autonomous vehicle 100B, and autonomous vehicle 100C, the travel controller 1033 of the autonomous vehicle 100A controls the drive unit 104 of the self-vehicle, so that the self-vehicle travels first in the platoon. Also, the travel controller 1033 of the autonomous vehicle 100B controls the drive unit 104 of the self-vehicle, so that the self-vehicle follows the autonomous vehicle 100A. Then, the travel controller 1033 of the autonomous vehicle 100C controls the drive unit 104 of the self-vehicle, so that the self-vehicle follows the autonomous vehicle 100B. As a result, the autonomous vehicles 100A to 100C can travel in a platoon in the form shown in FIG. 3. It is thus possible to reduce the consumption rate of the battery power in each of the three autonomous vehicles 100A to 100C, while minimizing the consumption rate of the battery power in the autonomous vehicle 100B having the smallest SOC.

According to the processing flow as described above, when two or more autonomous vehicles 100 travel in a platoon, the travelable distances of these autonomous vehicles 100 can be extended to the longest possible distances.

### First Modified Example of First Embodiment

If the autonomous vehicles 100 keep traveling in a platoon for a relatively long time, a situation where the SOC of the lead vehicle becomes smaller than that of any of the following vehicles may occur. Also, when three or more autonomous vehicles 100 travel in a platoon, a situation where the SOC of the tail-end vehicle becomes smaller than that of the autonomous vehicle 100 (intermediate vehicle) traveling at a position between the lead vehicle and the tail-end vehicle may occur. When platooning is continued in a condition where the above situations occur, it may become difficult to effectively extend the cruising distance of the lead vehicle or tail-end vehicle.

Thus, in this modified example, the server device 200 may monitor the SOC of the autonomous vehicles 100 traveling in a platoon, and may determine the traveling order again, when the relationship of the SOC among the autonomous vehicles 100 changes. For example, when the SOC of the autonomous vehicle 100A becomes smaller than the SOC of the autonomous vehicle 100B or autonomous vehicle 100C, while the three autonomous vehicles 100A to 100C are traveling in a platoon, in the order of the autonomous vehicle 100A, autonomous vehicle 100B, and autonomous vehicle 100C, the traveling position of the vehicle having the larger SOC, as one of the autonomous vehicle 100B and the autonomous vehicle 100C, is changed to the first (lead) position, and the traveling position of the autonomous vehicle 100A is changed to the second or subsequent position. At this time, if the autonomous vehicle 100A has the smallest SOC among the three vehicles, the traveling position of the autonomous vehicle 100A may be changed to the second position. Also, if the autonomous vehicle 100A has the second largest SOC among the three vehicles, the traveling position of the autonomous vehicle 100A may be changed to the third (tail-end) position.

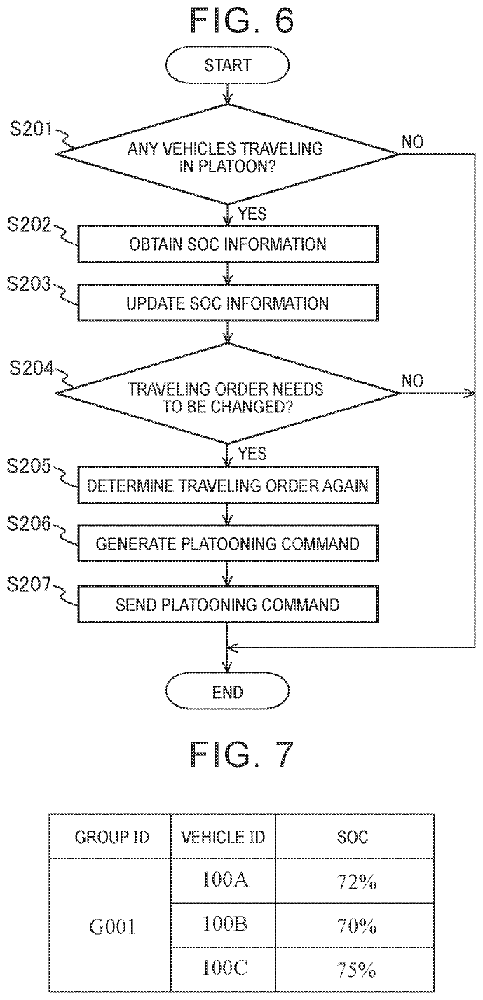

Here, the flow of processing of the server device 200 according to the modified example will be described. FIG. 6 is a flowchart illustrating the flow of processing performed by the server device 200, when two or more autonomous vehicles 100 are traveling in a platoon.

In FIG. 6, the traveling order determining unit 2024 of the server device 200 determines whether there are autonomous vehicles 100 traveling in a platoon. In this example, a platooning information table as shown in FIG. 7 is registered in the storage unit 203. The platooning information table like that of FIG. 7 is registered in the storage unit 203 when platooning is started (or a group of autonomous vehicles 100 that will travel in a platoon is determined), and is deleted from the storage unit 203 when the autonomous vehicles 100 finish traveling in the platoon. In the platooning information table shown in FIG. 7, information (group ID) for identifying the group of autonomous vehicles 100 that travel in a platoon is associated with information on the autonomous vehicles 100 that belong to each group. More specifically, the platooning information table has respective fields of the group ID, vehicle ID, and SOC, for example. In the group ID field, information (group ID) for identifying each group is entered. In the vehicle ID field, the vehicle IDs of the autonomous vehicles 100 that belong to each group are entered, and two or more vehicle IDs can be entered with respect to one group ID. In the SOC field, the SOC information indicating the SOC of the battery 105 in each autonomous vehicle 100 is entered, and the SOC information can be entered for each vehicle ID. In the example of FIG. 7, three autonomous vehicles 100A to 100C form one group, and travel in a platoon. The platooning information table as described above is registered in the storage unit 203, over a period from the start of platooning of each group to the end of platooning, as described above. Thus, when the platooning information table as described above is not registered in the storage unit 203, there are no autonomous vehicles 100 that are traveling in a platoon (a negative decision (NO) is obtained in step S201), and the processing by the server device 200 ends. On the other hand, when the platooning information table as described above is registered in the storage unit 203, there are autonomous vehicles 100 that are traveling in a platoon (an affirmative decision (YES) is obtained in step S201), and the server device 200 executes step S202 and subsequent steps.

In step S202, the SOC obtaining unit 2023 communicates with each of the autonomous vehicles 100 that are traveling in a platoon, via the communication unit 201, so as to obtain the SOC information at the current time of each autonomous vehicle 100. Then, the SOC obtaining unit 2023 accesses the platooning information table, and updates information in the SOC field of the table (step S203).

As described above, when the SOC information of each of the autonomous vehicles 100 that are traveling in a platoon is updated, the traveling order determining unit 2024 accesses the platooning information table corresponding to each group during platooning, and determines whether the traveling order in each group during platooning needs to be changed, by referring to the SOC information in the table (step S204). More specifically, if the SOC of the lead vehicle in each group becomes smaller than the SOC of the intermediate vehicle or tail-end vehicle, or the SOC of the tail-end vehicle in each group becomes smaller than the SOC of the intermediate vehicle, the traveling order determining unit 2024 determines that the traveling order of the autonomous vehicles 100 traveling in a platoon needs to be changed (an affirmative decision (YES) is obtained in step S204). In this case, the server device 200 executes step S205 and subsequent steps. When a negative decision (NO) is obtained in step S204, the processing by the server device 200 is finished.

In step S205, the traveling order determining unit 2024 determines the traveling order of the autonomous vehicles 100 in each group during platooning again, based on the latest SOC information registered in the SOC field of the platooning information table. For example, if the SOC (=72%) of the autonomous vehicle 100A that is traveling first becomes smaller than the SOC (=75%) of the autonomous vehicle 100C that is traveling at the tail end, as shown in FIG. 7, while the three autonomous vehicles 100A to 100C are traveling in a platoon, in the order of the autonomous vehicle 100A, autonomous vehicle 100B, and autonomous vehicle 100C, the traveling position of the autonomous vehicle 100A may be changed from the first (lead) position to the third (tail-end) position, and the traveling position of the autonomous vehicle 100C may be changed from the third (tail-end) position to the first (lead) position. When the autonomous vehicle 100A has the smallest SOC among the three vehicles, the traveling position of the autonomous vehicle 100A may be changed from the first position to the second position. Then, the traveling position of one of the autonomous vehicle 100B and the autonomous vehicle 100C having the larger SOC may be changed to the first position.

Once the traveling order of the autonomous vehicles 100 in each group during platooning is determined again, the operation command generating unit 2022 generates platooning commands again (step S206), according to the traveling order determined again in step S205. Then, the operation command generating unit 2022 sends a newly generated platooning command to each of the autonomous vehicles 100 in each group during platooning (step S207).

According to the processing flow as described above, even when the relationship of the SOC among the autonomous vehicles 100 changes from the one at the start of platooning, into a different relationship, while the autonomous vehicles 100 are traveling in a platoon, the travelable distances of these autonomous vehicles 100 can be extended with greater certainty.

### Second Modified Example of First Embodiment

In the case where two or more groups of the autonomous vehicles 100 traveling in platoons are set, if a group including the autonomous vehicle 100 having the smallest SOC is formed of the autonomous vehicles 100 having relatively small SOCs, it may be difficult to effectively extend the travelable distances of the autonomous vehicles 100 that belong to the group.

Thus, when two or more groups of the autonomous vehicles 100 traveling in platoons are set, grouping may be conducted such that the autonomous vehicle 100 having the largest SOC and the autonomous vehicle 100 having the smallest SOC belong to the same group. In this case, the autonomous vehicle 100 having the second largest SOC may belong to the same group as the autonomous vehicle 100 having the second smallest SOC, which group is different from the above group. With the groups thus determined in this manner, the travelable distances of the autonomous vehicles 100 that belong to each group can be extended to the longest possible distances.

### Second Embodiment

Next, a second embodiment will be described based on the drawings. Here, differences in the configuration between the above first embodiment and the second embodiment will be described, and the same or similar configuration will not be further described. In the first embodiment as described above, the traveling order is determined based on the SOC of each of the autonomous vehicles 100 for use in platooning. In this embodiment, the traveling order is determined based on a margin in each of the autonomous vehicles 100 for use in platooning. The “margin” mentioned herein is an excess of the travelable distance relative to the scheduled traveling distance of each autonomous vehicle 100, which is, for example, a difference obtained by subtracting the scheduled traveling distance from the travelable distance, or the ratio of the travelable distance to the scheduled traveling distance. In this embodiment, the ratio of the travelable distance to the scheduled traveling distance is used as the margin.

The scheduled traveling distance used when obtaining the margin is a distance of a route along which each autonomous vehicle 100 is scheduled to travel from the current position to a destination. The travelable distance used when obtaining the margin is a distance over which each autonomous vehicle 100 is supposed to be able to travel with the SOC at the current time, and is calculated from the distance over which each autonomous vehicle 100 is able to travel per unit amount of electric power (power consumption rate), and the SOC. The power consumption rate of each autonomous vehicle 100 is obtained in advance based on the result of experiments, simulation, etc. The power consumption rate of each autonomous vehicle 100 may vary depending on the number of users boarding the autonomous vehicle 100, and/or the quantity (or weight) of cargo loaded on the autonomous vehicle 100; thus, the power consumption rate may be corrected, in view of the number of users on board, the quantity of cargo loaded, and so forth.

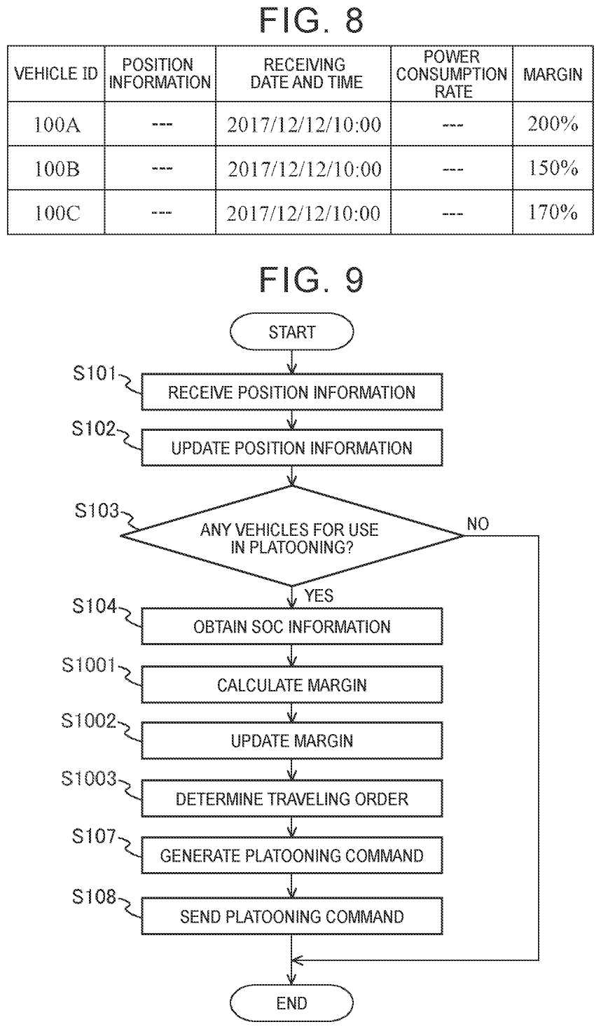

In this embodiment, an example of a vehicle information table stored in the storage unit 203 will be described based on FIG. 8. In the vehicle information table of this embodiment, the position information, receiving date and time, power consumption rate, and margin are associated with the vehicle ID of each autonomous vehicle 100. In the power consumption rate field, the power consumption rate of each autonomous vehicle 100 is entered. As described above, the information entered in the power consumption rate field is obtained in advance from the result of experiments or simulation. In the margin field, information indicating the margin of each autonomous vehicle 100 is entered. As described above, the information entered in the margin field is the ratio (=travelable distance/scheduled traveling distance) of the travelable distance to the scheduled traveling distance. The scheduled traveling distance is the length of the route along which each autonomous vehicle 100 is scheduled to travel from the current position to the destination, and is obtained based on map data, etc. stored in advance in the storage unit 203, etc. The travelable distance is calculated from the SOC information which the SOC obtaining unit 2023 receives from each autonomous vehicle 100, and the power consumption rate of each autonomous vehicle 100. For example, the travelable distance is obtained by calculating the amount of electric power stored in the battery 105 of each autonomous vehicle 100 based on the SOC information of the autonomous vehicle 100, and multiplying the amount of power by the power consumption rate. The information entered in the margin field is updated each time the SOC obtaining unit 2023 receives the SOC information from each autonomous vehicle 100.

### Flow of Processing

The flow of processing of the server device 200 according to this embodiment will be described. FIG. 9 is a flowchart illustrating the flow of processing performed by the server device 200, when two or more autonomous vehicles 100 traveling on the same route are detected. In FIG. 9, the same step numbers are assigned to the same steps as those of FIG. 5 as described above.

In FIG. 9, step S1001 and step S1002 are executed, in place of step S105 in FIG. 5 above, and step S1003 is executed, in place of step S106 in FIG. 5.

In step S1001, the SOC obtaining unit 2023 calculates the margin of each autonomous vehicle 100, based on the SOC information obtained in step S104. More specifically, the SOC obtaining unit 2023 obtains the scheduled traveling distance of each autonomous vehicle 100, from the length of the route along which the autonomous vehicle 100 is scheduled to travel from the current position to the destination. Also, the SOC obtaining unit 2023 accesses the vehicle information table corresponding to the vehicle ID of the autonomous vehicle 100, so as to read the power consumption rate entered in the power consumption rate field. Then, the SOC obtaining unit 2023 calculates the travelable distance of each autonomous vehicle 100, based on the power consumption rate read from the vehicle information table, and the SOC information obtained in step S104. Once the scheduled traveling distance and travelable distance of each autonomous vehicle 100 are obtained in this manner, the SOC obtaining unit 2023 obtains the margin of the autonomous vehicle 100, by dividing the travelable distance by the scheduled traveling distance. The margin obtained by the SOC obtaining unit 2023 is entered into the margin field of the vehicle information table, so that the information in the margin field is updated (step S1002).

In step S1003, the traveling order determining unit 2024 accesses the vehicle information table corresponding to each of the two or more autonomous vehicles 100 for use in platooning, and determines the traveling order of the autonomous vehicles 100, by referring to the information in the margin field of the table. In this embodiment, the traveling position of the autonomous vehicle 100 having the largest margin, among the two or more autonomous vehicles 100 for use in platooning, is set to the first position. In the case where there are three or more autonomous vehicles 100 for use in platooning, the traveling position of the autonomous vehicle having the second largest margin, among these autonomous vehicles 100, is set to the tail-end position, and the traveling position of the autonomous vehicle 100 having the smallest margin is set to a position between the lead vehicle and the tail-end vehicle, at which the traveling resistance is smallest. Here, when the three autonomous vehicles 100A to 100C indicated in FIG. 8 above are supposed to form a platoon in traveling, the traveling position of the autonomous vehicle 100A (margin=200%) having the largest margin is set to the first position. Also, the traveling position of the autonomous vehicle 100C (margin=170%) having the second largest margin is set to the third (tail-end) position. Then, the traveling position of the autonomous vehicle 100B (margin=150%) having the smallest margin is set to the second position (between the lead vehicle and the tail-end vehicle).

According to the processing flow as described above, when the autonomous vehicles 100 travel in a platoon, it is possible to extend the travelable distance of the autonomous vehicle 100 having the smallest margin, to the largest possible distance, while extending the travelable distances of the autonomous vehicles 100. Thus, the autonomous vehicle 100 having the smallest margin becomes able to accomplish the scheduled traveling distance with greater certainty.

### First Modified Example of Second Embodiment

If the autonomous vehicles 100 keep traveling in a platoon for a relatively long time, a situation where the margin of the lead vehicle becomes smaller than that of any following vehicle may occur. Also, where three or more autonomous vehicles 100 travel in a platoon, a situation where the margin of the tail-end vehicle becomes smaller than that of any intermediate vehicle may occur.

Thus, in this embodiment, the server device 200 may monitor the margins of the autonomous vehicles 100 traveling in a platoon, and determine the traveling order again, when the relationship in the margin among the autonomous vehicles 100 changes. For example, when the margin of the autonomous vehicle 100A becomes smaller than that of the autonomous vehicle 100B or autonomous vehicle 100C, while the three autonomous vehicles 100A to 100C are traveling in a platoon, in the order of the autonomous vehicle 100A, autonomous vehicle 100B, and autonomous vehicle 100C, the traveling position of the vehicle, as one of the autonomous vehicle 100B and the autonomous vehicle 100C, which has the larger margin is changed to the first (lead) position, and the traveling position of the autonomous vehicle 100A is changed to the second or subsequent position. At this time, if the autonomous vehicle 100A has the smallest margin, among the three vehicles, the traveling position of the autonomous vehicle 100A may be changed to the second position. Also, if the autonomous vehicle 100A has the second largest margin, among the three vehicles, the traveling position of the autonomous vehicle 100A may be changed to the third (tail-end) position.

According to this modified example, even when the relationship in the margin among the autonomous vehicles 100 is changed to the one that is different from the relationship at the start of platooning, while the autonomous vehicles 100 are traveling in a platoon, the travelable distances of the autonomous vehicles 100 can be extended with greater certainty. As a result, the autonomous vehicles 100 traveling in a platoon are able to accomplish the scheduled traveling distance with greater certainty.

### Second Modified Example of Second Embodiment

In the case where two or more groups of the autonomous vehicles 100 traveling in platoons are set, if a group including the autonomous vehicle 100 having the smallest margin is formed of the autonomous vehicles 100 having relatively small margins, it may be difficult for the autonomous vehicles 100 that belong to the group to accomplish the scheduled traveling distances.

Thus, when two or more groups of the autonomous vehicles 100 traveling in platoons are set, grouping may be conducted such that the autonomous vehicle 100 having the largest margin and the autonomous vehicle 100 having the smallest margin belong to the same group. In this case, the autonomous vehicle 100 having the second largest margin may belong to the same group as the autonomous vehicle 100 having the second smallest margin, which group is different from the above group. With the groups thus determined in this manner, the autonomous vehicles 100 that belong to each group are more likely to accomplish the scheduled traveling distances with greater certainty.

### Other Embodiments

While the electric automobile is used as the autonomous vehicle in each of the above embodiments and modified examples, a fuel automobile on which an internal combustion engine is installed as the motor, and which operates the internal combustion engine, using fuel, such as gasoline or light oil, as the operation source, may be used as the autonomous vehicle. In this case, the traveling order of the autonomous vehicles traveling in a platoon may be determined, based on the remaining amount of the fuel (such as gasoline or light oil) that serves as the operation source of the internal combustion engine. At this time, the traveling order may be determined, based on the relationship in the remaining fuel amount among the vehicles for use in platooning, or the traveling order may be determined, based on the relationship in the margin among the vehicles for use in platooning. The margin in the case where the fuel automobiles are used as the autonomous vehicles may be calculated, based on the travelable distance calculated from the remaining fuel amount and fuel consumption rate of each vehicle, and the scheduled traveling distance of each vehicle.

As the autonomous vehicles under the control of the server device, one or more electric automobiles and one or more fuel automobiles may be included. In this case, the traveling order may be determined, based on the relationship in the margin among the vehicles for use in platooning.

It is to be understood that the embodiments and modified examples as described above are mere examples, and the embodiment may be embodied with changes as needed, without departing from the principle of the disclosure. Also, the processes or means described in this disclosure may be freely combined and implemented, unless they are technically inconsistent. Further, a process described as being performed by a single device may be divided and performed by two or more devices. As an alternative, processes described as being performed by different devices may be performed by a single device. In a computer system, the hardware configuration that implements each function may be flexibly changed.

Also, this disclosure may be practiced by supplying a computer program for implementing the functions described in each of the above embodiments and modified examples, to a computer, and causing one or more processors included in the computer to read and run the program. The computer program may be provided to the computer, via a non-temporary computer-readable storage medium that can be connected to a system bus of the computer, or may be provided to the computer via a network. The non-temporary computer-readable storage medium is a recording medium that can store information, such as data and programs, by electric, magnetic, optical, mechanical, or chemical action or operation, such that the information can be read from a computer, or the like. The non-temporary computer-readable storage medium may be selected from media including, for example, certain types of discs, such as magnetic discs (floppy disc (registered trademark), hard disc drive (HDD), etc.), and optical discs (CD-ROM, DVD disc, blue-ray disc, etc.), read-only memory (ROM), random access memory (RAM), EPROM, EEPROM, magnetic card, flash memory, optical card, SSD (solid state drive), and so forth.

What is claimed is:

1. An information processing system that manages traveling of a plurality of autonomous vehicles when the autonomous vehicles travel in a platoon, each of the autonomous vehicles being equipped with a motor, and an operation source as a substance consumed for operating the motor, the information processing system comprising a controller configured to:
obtain a parameter correlated with an operation source remaining amount as a remaining amount of the operation source installed on each of the autonomous vehicles; and
determine a traveling order of the autonomous vehicles traveling in the platoon, based on the parameter of each of the autonomous vehicles.

2. The information processing system according to claim 1, wherein:
the controller is configured to obtain the operation source remaining amount of each of the autonomous vehicles, as the parameter; and
the controller is configured to determine the traveling order, such that one of the autonomous vehicles having the largest operation source remaining amount takes a lead in the platoon.

3. The information processing system according to claim 1, wherein the controller is configured to:
estimate a travelable distance of each of the autonomous vehicles, based on the operation source remaining amount of each of the autonomous vehicles;
obtain a scheduled traveling distance of each of the autonomous vehicles;
calculate a margin of the travelable distance relative to the scheduled traveling distance, with respect to each of the autonomous vehicles, to obtain the margin of each of the autonomous vehicles as the parameter; and
determine the traveling order, such that one of the autonomous vehicles having the largest margin takes a lead in the platoon.

4. The information processing system according to claim 1, wherein:
the controller is configured to determine whether the traveling order needs to be changed, based on the parameter of each of the autonomous vehicles obtained while the autonomous vehicles are traveling in the platoon; and
the controller is configured to determine the traveling order again, based on the parameter of each of the autonomous vehicles, when the controller determines that the traveling order needs to be changed.

5. The information processing system according to claim 1, wherein the controller sets a plurality of groups of the autonomous vehicles that travel in platoons, such that one of the autonomous vehicles having the largest parameter and one of the autonomous vehicles having the smallest parameter are included in the same group.

6. An information processing method for managing traveling of a plurality of autonomous vehicles when the autonomous vehicles travel in a platoon, each of the autonomous vehicles being equipped with a motor, and an operation source as a substance consumed for operating the motor, the information processing method comprising:
obtaining a parameter correlated with an operation source remaining amount as a remaining amount of the operation source installed on each of the autonomous vehicles, by a computer; and
determining a traveling order of the autonomous vehicles traveling in the platoon, based on the parameter of each of the autonomous vehicles, by the computer.

7. A non-transitory storage medium storing an information processing program for managing traveling of a plurality of autonomous vehicles when the autonomous vehicles travel in a platoon, each of the autonomous vehicles being equipped with a motor, and an operation source as a substance consumed for operating the motor, the information processing program causing a computer to execute the steps of:
obtaining a parameter correlated with an operation source remaining amount as a remaining amount of the operation source installed on each of the autonomous vehicles; and
determining a traveling order of the autonomous vehicles traveling in the platoon, based on the parameter of each of the autonomous vehicles.
